(19) United States
(12) Patent Application Publication
(10) Pub. No.: US 2004/0128350 A1
(43) Pub. Date: Jul. 1, 2004

(54) Methods and systems for real-time virtual conferencing

(76) Inventors: Lou Topfl, Atlanta, GA (US); Barrett Kreiner, Norcross, GA (US)

Correspondence Address: SCOTT P. ZIMMERMAN PLLC, P.O. BOX 3822, CARY, NC, 27519, US

(21) Appl. No.: 10/105,696

(22) Filed: Mar. 25, 2002

(51) Int. Cl. G06F 15/16; G09G 5/00

(52) U.S. Cl. 709/204; 345/757

(57) ABSTRACT

A conferencing system provides an interactive virtual world representing a real or imaginary place using graphics, images, multimedia, and audio data. The system includes a communications network, at least one local client processor/server operatively connected to the communications network operable for virtual environment and avatar rendering using a descriptive computer markup language and further operable for coordinating virtual environment and avatar state changes, at least one input device operable for performing the virtual environment and avatar state changes, and an output device operable for displaying the virtual conference environment. The system operates using a low bandwidth dependency. A virtual conference is created using human, environment, gesture, voice, and phonetic descriptive markup languages. A software-based virtual conferencing system that does not require cameras, video translation devices, or any other additional equipment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The present invention relates generally to the field of video conferencing. More specifically, the present invention relates to methods and systems for providing real-time software-based virtual conferencing without the use of cameras and video translation devices.

### BACKGROUND OF THE INVENTION

A conventional video conference system is an application which processes consecutive media generated by digitizing speech and dynamic images in real-time in a distributed environment using a network. Such video conferencing systems may be used to conduct real-time interactive meetings, thus eliminating the need for conference participants to travel to one designated location. Video conferences may include voice, data, multimedia resource, and imaging communications. Conventional video conferencing systems typically include complicated and expensive equipment, such as cameras, video translation devices, and high speed local area network (LAN) and wide area network (WAN) connections.

In one conventional video conferencing approach, apparatus are used that are operable for the real-time live imaging of conference participants. These conventional systems typically include a video camera disposed in front of each conferee operable for capturing live images of conference participants at designated time intervals. The live images are then sent as video signals to a video processor, wherein the video processor then sends them through the network to the conference participants. This approach includes the use of additional expensive and complicated cameras and video processing equipment. This approach also requires each individual conferee to have his/her own camera and video processor.

A disadvantage to this type of conventional video conferencing system, aside from the expensive video equipment needed, involves having to take a visual frame, scanning network connection lines, and using several different algorithms to calculate image position changes so that updated images can be sent. An updated image must be sent quickly through the network connection line so that conferees view the conference in real-time. Another disadvantage to this type of conventional video conferencing system involves compacting a large amount of video data down into a small amount of data so that it can fit on the size of the network connection line, such as an Integrated Services Digital Network (ISDN).

A second conventional video conferencing approach, such as Microsoft's Net Meeting™, also requires a camera and video translation equipment, but is able to compress data into a smaller bandwidth. In this approach, a low resolution snapshot is taken of a person incrementally and the information is sent across the communication line. The disadvantages to this approach again lie with the quality of the image presented to the conferees and in bandwidth dependencies. On the other side of the connection, especially if the connection is disruptive or of a low bandwidth, the images are often blocky and very hard to see. For a video conference to be effective, conference participants must be able to clearly view everything that takes place in a location, including people, presentations, and facial expressions.

Different algorithms have been developed for the purpose of taking a static bit of information and running a large compression on it to improve picture quality. One problem with this approach is that the image presented is not done so in real-time. What is desirable is to minimize the degradation of an image, and instead of sending frame by frame differences, to actually create a digital representation of the person on the other end of the connection.

A third approach to visual conferencing involves the use of talking icons. Talking icons, which are typically scanned in or chosen by a presenter from a palette, are small avatars that read a text document, such as an email. Talking icons are very limited in the number of gestures that they are able to perform and do not capture the full inflection of the person that they represent, or the represented person's image. Also, the use of simulated talking icons is not as desirable as providing a real-time personal 3D image within a virtual conference facility map.

U.S. Pat. No. 5,491,743 discloses a virtual conferencing system comprising a plurality of user terminals that are linked together using communication lines. The user terminals each include a display for displaying the virtual conference environment and for displaying animated characters representing each terminal user in attendance at the virtual conference. The user terminals also include a video camera, aimed at the user sitting at the terminal, for transmitting video signal input to each of the linked terminal apparatus so that changes in facial expression and head and/or body movements of the user sitting in front of the terminal apparatus are mirrored by their corresponding animated character in the virtual conference environment. Each terminal apparatus further includes audio input/output means to transmit voice data to all user terminals synchronous with the video transmission so that when a particular person moves or speaks, his actions are transmitted simultaneously over the network to all user terminals which then updates the computer model of that particular user animated character on the visual displays for each user terminal.

The conventional video conferencing methods described above increase the complexity of conferee interaction and slow the rate of the interaction due to the amount of data being transmitted. What is desired is a real-time simulation of a face-to-face meeting using an inexpensive and uncomplicated multimedia conferencing system without having to use expensive cameras and video translation devices.

### BRIEF SUMMARY OF THE INVENTION

In one embodiment, the present invention provides an interactive virtual world representing a real or imaginary place using graphics, images, multimedia, and audio data. What is further provided is a system in which the virtual world is created and operated using a low bandwidth dependency. The virtual world enables a plurality of conference participants to simultaneously and in real-time perceive and interact with the virtual world and with each other through computers that are connected by a network. The present invention solves the problems associated with the conventional video conferencing systems described above by providing a software-based virtual conferencing system that does not require expensive cameras, video translation devices, or any other additional equipment.

According to the present invention, to attain the above objects, a virtual conferencing system, comprises: a communications network, at least one local client processor/server operatively connected to the communications network and operable for virtual environment and avatar rendering using a descriptive computer markup language, a central server acting as a broker between the at least one local client processor/server and operable for coordinating virtual environment and avatar state changes, at least one input device operable for performing the virtual environment and avatar state changes, and an output device operable for displaying the virtual conference environment.

In one embodiment, the virtual conferencing system descriptive computer markup language comprises an extensible markup language (XML) comprising at least one of: a human markup language used to describe an avatar, a virtual conference environment language, an environment modification language, a gesture markup language, a voice characteristic markup language, and a phonetic markup language. A major advantage to using markup languages relates to bandwidth dependencies, such as being able to access a virtual conference using a low speed analog dial-up connections.

The virtual conferencing system of the present invention further comprises an audio input device operable for inputting conference participants voice communications, such as a microphone, and an audio output device operable for outputting the conference participants voice communications, such as a speaker. Voice communications are handled using voice over Internet Protocol technology or may be handled out of band via a separate circuit-switched conference bridge.

Conference participants of the present invention are represented, either realistically or unrealistically, using an avatar created using the human markup language. Using the markup language, a conference participant has flexibility in creating any type of animated character to represent him/herself. Animated characters can be controlled by one or more participants, and one participant can control more than one animated character. The animated characters are moved anywhere within the virtual environment using an input device operatively connected to the processor/server. For example, the directional arrows of a keyboard may be used to walk an avatar around a virtual conference room while the line of sight is controlled using a mouse. Actuating the mouse buttons may activate tools disposed within the conference room. An avatar's behavior is also controlled by synchronizing the avatar's facial expressions with the voice of the conference participant.

One processor/server may function as a central server and is operable for sending full state information at regular intervals for the purpose of correcting discrepancies between the conference participants and their avatars caused by lost or damaged data. During a virtual conference, state changes are transmitted over the network to participant processors/servers, so that when one participant performs an action with his avatar within the virtual room, the server sends this information to the other participants so the other participants see participant one's avatar performing the action. For example, when participant one's avatar is directed to point to a drawing on a screen, all other participants see participant one's avatar pointing to the screen.

The present invention further provides a method of conferencing a plurality of client processors/servers that are connected via a global communication network. The method first includes the steps of creating, at a first local client processor/server, a virtual conference environment using a descriptive environment markup language and creating a first personal avatar of the first local client processor/server using a descriptive human markup language. Next, communication is established between the first local client processor/server and a second local client processor server utilizing an Internet Protocol address, wherein the conference communication comprises data and audio information. Then, virtual conference environment data and avatar data is transmitted from the first local client processor/server to the second local client processor/server via the global communication network. A second personal avatar of the second local client processor/server is created using the descriptive human markup language. The first and second local clients are able to interactively participate in a virtual conference, via the communication network, by performing avatar actions within the virtual conference environment. The first and second local clients are able to change the virtual conference environment using the descriptive environment markup language.

All conference participants are able to change the virtual conference environment over time and on the fly. Conference tools and elements can be introduced, destroyed, and modified depending upon participant needs and preferences. What is provided by the present invention is a totally interactive and modifiable environment. While a realistic environment can be created, a totally unrealistic environment can also be created. For example, it may be desirable for a zero gravity environment to exist.

In an alternative embodiment, the present invention comprises a communication network capable of establishing a connection between a plurality of conference participants for the purpose of performing a virtual conference. The communication network includes at least one processor/server in the communication network comprising a virtual conferencing software module disposed within a memory system, wherein the virtual conferencing software module supports a structure and layout of a virtual conference room, animated avatars, tools, and interactions of the animated avatars within the virtual conference environment, wherein the memory system includes information for the appearance of the avatars that populate the virtual environment, conference facilities, documents, and multimedia presentation materials, and wherein the virtual conference processor/server acts as a broker between a plurality of local client processors/servers and is operable for coordinating virtual environment and avatar state changes. At least one input device is operatively connected to the processor/server and is operable for performing virtual environment and avatar state changes. At least one output device operatively connected to the processor/server and is operable for outputting audio data, displaying a virtual conference environment, displaying a plurality of avatars, and displaying the virtual environment and avatar state changes.

In yet a further embodiment, the present invention provides a system for creating a virtual conference. The system includes a human markup language used to describe an avatar representing a conference participant, wherein the avatar comprises a direct representation of the conference participant, an environment markup language used to describe a virtual conference setting, multimedia, and conference tools, a gesture markup language used to direct actions of the avatar after it has been described, a voice characteristic markup language used to describe the characteristic's of the conference participant's voice and repeatable idiosyncrasies of the voice, and a phonetic markup language used to provide the continuous audio description of the conference participant, wherein markup language streams are exchanged between a plurality of conference participants.

The presentation of the virtual conference room is assembled within the conference participant's resources, and the quality of presentation of the conference room is based upon the participant's resource capabilities. By using a markup language system to create a virtual conference, the markup languages allows conference participants to replay, ignore, mute, focus, and change vantage points both possible and physically impossible on the fly.

Additional objects, advantages, and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a block diagram illustrating the connection of local client processor/server apparatus used for virtual conferencing in accordance with an exemplary embodiment of the present invention;

FIG. 2 is a block diagram of one of the local client processor/server apparatus of FIG. 1 in accordance with an exemplary embodiment of the present invention;

FIG. 3 is a flowchart providing an overview of a method of conferencing a plurality of client processors/servers connected via a global communication network in accordance with an exemplary embodiment of the present invention; and

FIG. 4 is a block diagram illustrating a virtual conference room containing a plurality of avatars each representative of a conference participant in accordance with an exemplary embodiment of the present invention.

### DETAILED DESCRIPTION OF THE INVENTION

As required, detailed embodiments of the present invention are disclosed herein, however, it is to be understood that the disclosed embodiments are merely exemplary of the invention that may be embodied in various and alternative forms. Specific structural and functional details disclosed herein are not to be interpreted as limiting, but merely as a basis for the claims as a representative basis for teaching one skilled in the art to variously employ the present invention.

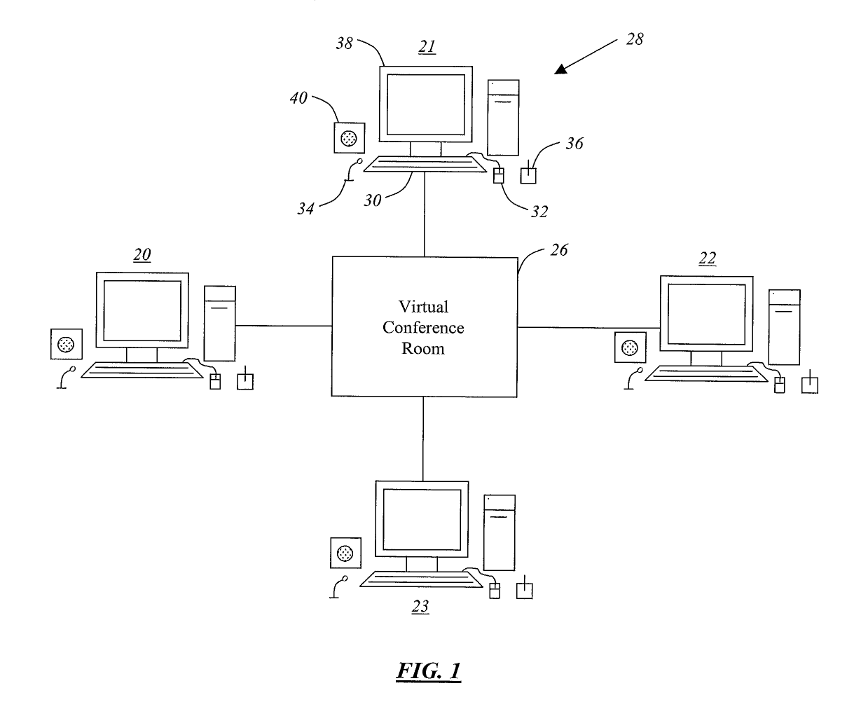

Referring now to the drawings, in which like numerals indicate like elements throughout the several figures, FIG. 1 illustrates a block diagram of a virtual conferencing arrangement according to the present invention. There may be up to n number of conference participants included in a virtual conference, where n is a number larger than two, that may visually and aurally communicate with one another. For example, four such conferees 20, 21, 22, 23 located anywhere in the world are shown in FIG. 1. Conferees 20, 21, 22, and 23 meet in a virtual conference room 26. The virtual conference room 26 allows remote real world participants to meet and interact instantly, without delay due to travel. Conferees 20, 21, 22, and 23 access the virtual conference room 26 via a personal computer, personal digital assistant (PDA), or other like apparatus. As shown in FIG. 1 in an exemplary embodiment, the processor/server apparatus 28, such as a personal computer, comprises a plurality of input and output devices. Input devices can include a keyboard 30, a mouse 32, a microphone 34, and a joystick 36. Output devices can include a display 38, one or more audio speakers 40, a headset of a telephone, and a printer. Some devices, such as a network interface and a modem can be used as input/output devices.

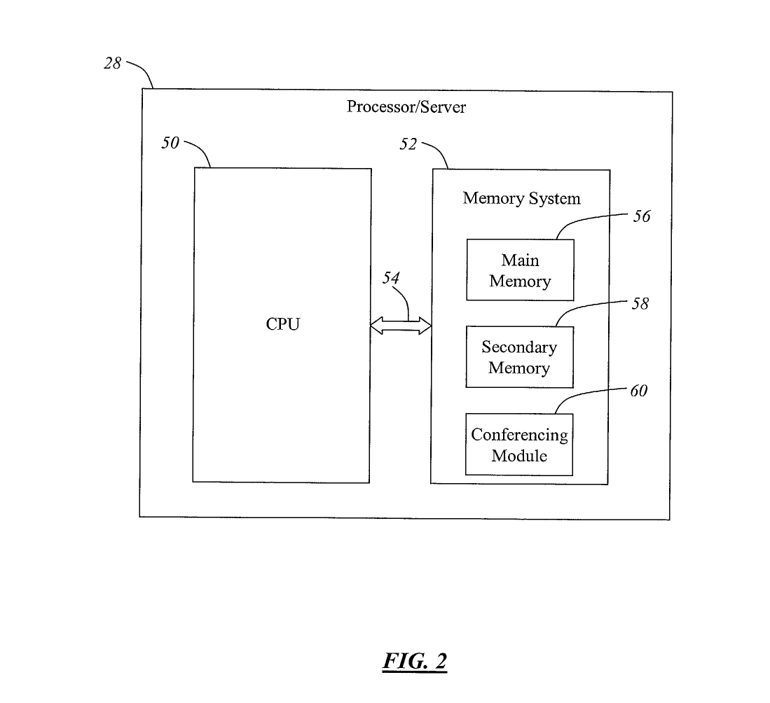

Referring to FIG. 2, the processor/server apparatus 28 further comprises at least one central processing unit (CPU) 50 in conjunction with a memory system 52. These elements are interconnected by at least one bus structure 54. The CPU 50 of the processor/server 28 is operable for performing computations, temporarily storing data and instructions, and controlling the operations of the processor/server 28. The CPU 50 may be a processor having any of a variety of architectures including those manufactured by Intel, IBM, and AMD, for example. The memory system 52 generally includes high-speed main memory 56 in the form of a medium such as Random Access Memory (RAM) and Read Only Memory (ROM) semiconductor devices. The memory system 52 also includes secondary storage memory 58 in the form of long term storage mediums such as hard drives, CD-ROM, DVD, flash memory, etc., and other devices that store data using electrical, magnetic, optical, or other recording media. Those skilled in the art will recognize that the memory system 52 can comprise a variety of alternative components having a variety of storage capacities.

Many computer systems serving as processors/servers 28 are distributed across a network, such as the Internet, for simultaneous virtual conferences. Connections work for dial-up users as well as users that are directly connected to the Internet (e.g. ADSL, cable modem, T1, T3, etc.). Each participant in a conference according to the present invention is connected via a low speed analog dial-up connection, a local area network, a wide area network, a public switched telecommunications network (PSTN), intranet, Internet, or other network to a remote processor/server 28 of another conference participant. Since the present invention operates effectively without the need for cameras and video translation equipment, the basic requirements are only that of a low speed analog dial-up connection.

The processor/server 28 further includes an operating system and at least one application program. The operating system is a set of software that controls the processor/server's 28 operation and the allocation of resources. The application program is a set of software that performs a task desired by the user, using computer resources made available through the operating system. Both are resident in the illustrated memory system 52.

The present invention is described below with reference to acts and symbolic representations of operations that are performed by a processor/server 28, unless indicated otherwise. Such acts and operations are sometimes referred to as being computer-executed and may be associated with the operating system or the application program as appropriate. It will be appreciated that the acts and symbolically represented operations include the manipulation by the CPU 50 of electrical signals representing data bits which causes a resulting transformation or reduction of the electrical signal representation, and the maintenance of data bits at memory locations in memory system 52 to thereby reconfigure or otherwise alter the processor/server's 28 operation, as well as other processing of signals. The memory locations where data bits are maintained are physical locations that have particular electrical, magnetic, or optical properties corresponding to the data bits.

Each conference participant is provided with a processor/server 28 comprising a virtual conferencing software module 60 disposed within the memory system 52. The virtual conferencing software module 60 supports the structure and layout of the virtual conference room, animated characters, tools, and how the animated characters or avatars interact in the virtual conference environment. The memory system 52 includes the information for the appearance of the avatars that populate the virtual environment, the conference facilities, documents, multimedia presentation materials, etc. An avatar for each conference participant is created using a markup language and may be stored within each conference participant's memory system 52. Transmission of bandwidth intensive full frame video is unnecessary since only changes in position data of an avatar, as directed by a conferee using an input device such as a keyboard (30, FIG. 1), are sent over the low speed analog connection to update avatar movements within the virtual conference environment.

Conference data can include an identification (ID) portion and a data portion. The ID portion consists of a generator/sender ID indicating a participant's processor/server 28 identifier. An identifier identifies a processor/server 28 or device on a TCP/IP network. Networks use the TCP/IP protocol to route messages based on the IP address of the destination. Conventionally, the format of an IP address is a 32-bit numeric address written as four numbers separated by periods. Each number can be zero to 255. For example, 1.132.15.225 could be an IP address of one conference participant. Within an isolated network, an IP address for a participant can be assigned at random as long as each one is unique. The four numbers in an IP address are used in different ways to identify a particular network and conference participants on that network. Conferees will typically be able to initiate or log-on to a conference by clicking, for example, on a dialing icon for out dialing an IP address or outputting an Internet address. A receiver ID indicates a participant processor/server 28 of the receiver of the transmission data. The data portion contains data specific to a virtual conference and data generated by each conference participant. Examples of the data specific to the virtual conference indicates such states as a position change of the associated participant, characteristics of an avatar, a direction that an avatar is facing, opening and closing of his/her mouth, and gestures, etc.

Other than dialing and markup language software, there may initially be no special software loaded onto a participant's processor/server 28. A participant may request the downloading to the processor/server 28 of any required software prior to or during a conference. Also, a participant may automatically receive certain software whether they specifically requested the software or not. The requested or automatic downloading to the participant of special application software may be initiated and/or the software shared between processors/servers 28. An out-dialed IP address signifies a connection through the network to another participant's processor/server 28. Once connected to a processor/server 28, a conference information screen may appear on the display 38 that gives conference details, such as participant information, time, virtual location, and functional items being used.

Data specific to the transmission data output from the processor/server 28 further includes data respectively indicating attendance at the virtual conference, withdrawal from the conference, a request for operation rights, and permission for operation rights. The CPU 50 performs such operations as processing a request for generating or terminating a virtual conference, and receiving a request for speaking rights. Furthermore, the processor/server 28 sends such data as new attendance at the conference and replacement of an operator having the operation right of application to each participant so that the content of a conference is updated in a frequent manner.

The first participant processor/server 28 may function as a central server that initiates a virtual conference. The server acts as a broker between participants. A conference is initiated by a participant first creating the virtual conference room 26 using a conference room markup language. Once a conference room 26 has been created, participant processors/servers 28 are then contacted using IP addresses, as described above. Processors/servers 28 are connected such that when participant 20 performs an action with his avatar within the virtual room, the server sends this information to participants 21, 22, and 23 so that participants 21, 22, and 23 see participant 20's avatar performing the action. For example, when participant 20's avatar is directed to point to a drawing on a screen, participants 21, 22, and 23 see participant 20's avatar pointing to the screen.

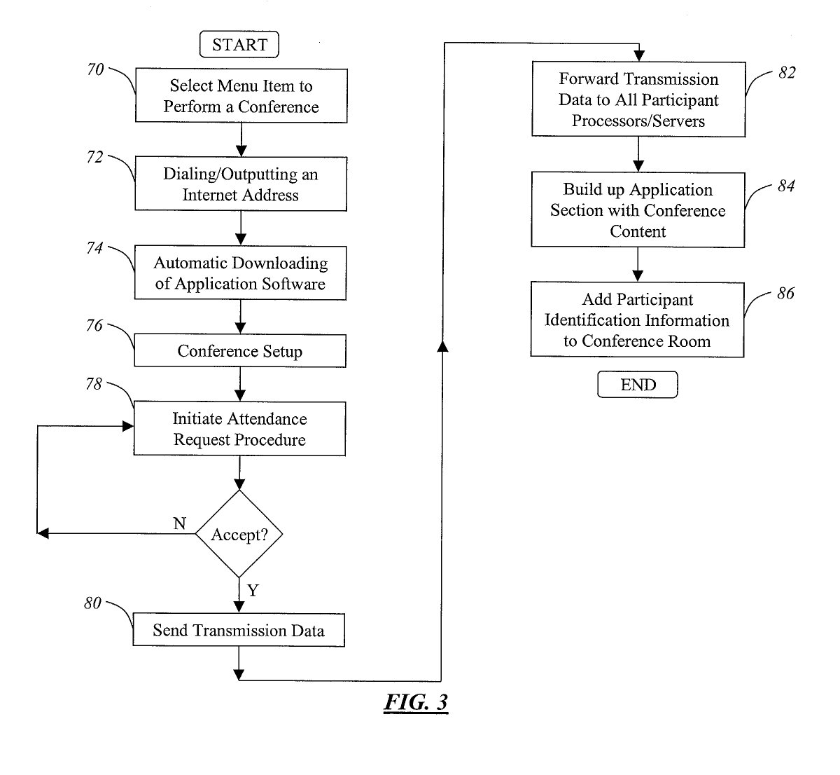

Referring to FIG. 3, step 70, when a participant selects a processing menu item to perform a conference, a virtual conference room window showing the overall view of a conference room pops up on a display screen of the display 38 of the computer system. A conference room list window may be displayed which shows a list of conferences currently underway and their respective participants. The operators of all processors/servers 28 connected to the network may be displayed in a conference window as persons allowed and able of attending a conference. Alternatively, only the selected participants may be displayed as allowable persons in accordance with the type and subject matter of a conference.

In step 72, in order for a participant to log on to an ongoing conference or to initiate a new conference, the conferee will typically click, for example, on a dialing icon for out dialing an address or outputting an Internet address. The requested or automatic downloading to the user of application software may then be initiated or shared from a processor/server 28 in step 74. The out dialed address signifies a connection through the network (Internet or other network) to a processor/server 28 of another conferee. In step 76, once connected to the processor/server 28, a set-up screen may be generated by the processor/server 28 for presentation to a conferee to permit room set-up, conference time, personal information, screen layout, and invitations. Invitations may be sent out using an attendance request window which asks for a response as to whether or not an invitee will attend the conference displayed on the display 38.

In step 78, the processor/server 28 that requests the attendance of another participant completes the attendance request procedure if the processor/server 28 receives data indicating the refusal of attendance of another conferee, or receives no response from the user processor/server 28 because of an absence of an operator.

In step 80, when another invited participant accepts the attendance, transmission data including data indicating the acceptance of attendance is returned to the processor/server 28 of the attendance requesting conferee. In this case, the conferee on the requesting side sends transmission data, including data indicating the attendance of the new participant at the conference, to the processor/server 28. In response, the processor/server 28 forwards the transmission data to all other participant's processors/servers 28 identifying the newly joined participant in step 82. In step 84, the newly joined participants processor/server 28 performs an operation to transmit data etc., necessary to build up the application section with the virtual conference room content. Furthermore, in step 86, the newly joined participant's processor/server 28 sends transmission data including identification information to the conference room so that the new participant is added to the conference room.

In accordance with a preferred embodiment of the invention, environment and avatar rendering is performed using local user software that is pre-loaded on the virtual conferencing software module (60, FIG. 2). Each conference participant operates a 3D (three-dimensional) personal image, or avatar, within a virtual conference facility map. The avatar and the conference facility map are expressed by a language, such as a markup language, that describes the features of the participants and the virtual environment.

In one embodiment, the markup language comprises that of an Extensible Markup Language (XML). An XML descriptive language can be used to describe characteristics of a conference participant, gestures, voice characteristics, phonetics, and the virtual conference environment. XML is a set of rules operable for structuring data, not a programming language. XML improves the functionality of the Internet by providing more flexible and adaptable identification information. Extensible means that the language is not a fixed format like HyperText Markup Language (HTML). XML is a language for describing other languages, which allows a conference participant to design his/her own customized markup languages for limitless different types of applications. XML is written in Standard Generalized Markup Language (SGML), which is the international standard metalanguage for text markup systems. XML is intended to make it easy and straightforward to use SGML on the Web, easy to define document types, easy to transmit them across the Web, and easy to author and manage SGML defined documents. XML has been designed for ease of implementation and for interoperability with both SGML and HTML. XML can be used to store any kind of structured information and to encapsulate information in order to pass it between different processors/servers 28 which would otherwise be unable to communicate.

XML is extensible, platform-independent, and supports internationalization and localization. XML makes use of “tags” (words bracketed by “<” and “>”) and “attributes” (of the form (name=“value”)). XML provides a participant the ability to define what the tags are. While HTML specifies what each tag and attribute means, and how the text between them will look in a browser, XML uses the tags only to delimit pieces of data, and leaves the interpretation of the data completely to the application that reads it. In other words, a “<p>” in an XML file can be a parameter, person, place, etc. The rules for XML files are strict, meaning that a forgotten tag or an attribute without quotes makes an XML file unusable. XML specification forbids applications from trying to second-guess the creator of a broken XML file; if the file is broken, an application has to stop and report an error in the place that the error occurred.

For the virtual conferencing application of the present invention, XML is an ideal markup language due to its bandwidth requirements. Since XML is a text format and uses tags to delimit data, XML files tend to be larger than comparable binary formats. The advantages of a text format are evident, and the disadvantage of file size can be compensated for by compressing data using compression programs like zip and communication protocols that compress data on the fly, saving bandwidth as effectively as a binary format. Also, by using XML as the basis for creating a virtual conference environment and characters, a conference participant gains access to a large and growing community of tools and engineers experienced in the technology. A participant still has to build their own database and their own programs and procedures that manipulate it, but there are many tools available to aid a user. Since XML is license-free, a participant can build their own software around it without having to pay anyone for it.

The present invention provides various markup languages for virtual video conferencing as opposed to using audio/video streams. The markup streams move between participant's processors/servers 28 instead of the audio/video streams, with the presentation for a participant being assembled not within the space, but within the participant's resources. The quality of the presentation for a given participant is based on that participant's device capabilities, and not the capabilities of the space. Conventional video conferencing approaches expressly expect increasing the bandwidth to handle the video and audio streams to increase the quality of the presentation. In the present invention, bandwidth remains low and consistent. To increase the quality of presentation, the local resources of a participant need to be enhanced. Also, participants having different resources have a different quality of presentation, but do not directly know the quality of presentation of the other participants.

Various markup languages are used instead of audio/video streams. By using a markup language that does not require large amounts of data, verbal gestures, movements, etc. may be sent across the communication lines. If a line is noisy, the avatars are still present and not blocky in image, but may pause for a moment. A human markup language is used to physically describe an avatar that may or may not be a direct representation of a conference participant. An avatar is defined as an interactive representation of a human in a virtual environment. Conference participants are able to create their own unique avatars which may be saved within their memory system 52. The avatar works in a 3D virtual conference environment, and both the avatar and the environment are configurable. The human markup language is used to create a participants digital representation by describing a persons elements, such as male, about this tall, weight, skin color, glasses, hair color, hair style, clothing, etc. The general appearance of a human being can basically be described using a few hundred elements. In one example, an avatar can be created in a realistic manner, such as possessing characteristics that a human possesses. In another example, a participant can create an unrealistic avatar, such as having a blue skin tone which can indicate that a participant is feeling sad.

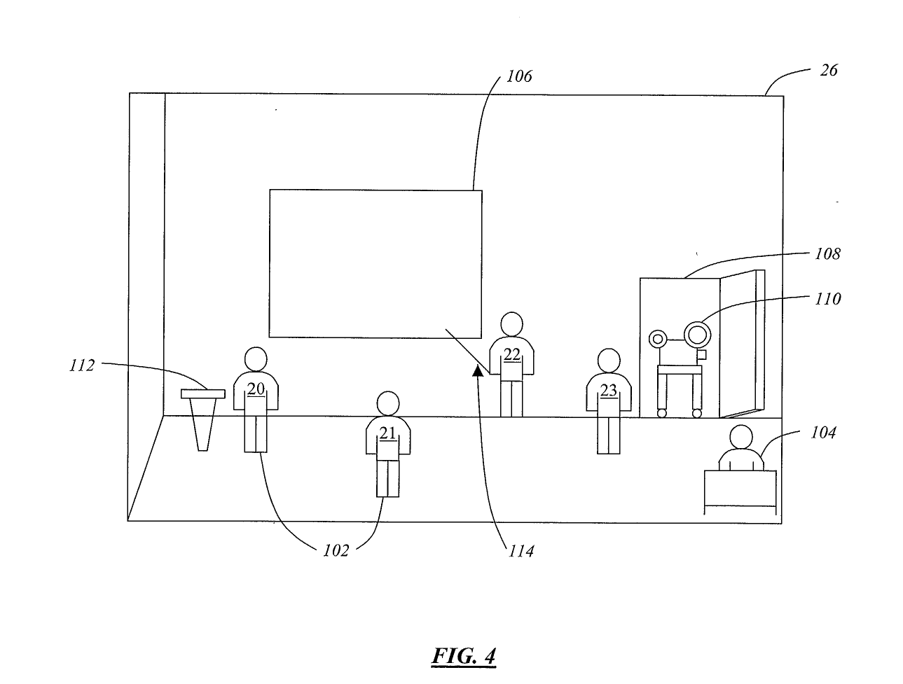

FIG. 4 is a schematic illustration of an exemplary virtual area, space, or conference room (26, FIG. 1) within a virtual world conferencing environment that represents a real or imaginary place using graphic and audio data that are presented to participants. A digital environment is superior to a physical environment in many ways. For example, realistic and unrealistic views can be created, 360 degree panoramic views can be created, and elements such as gravity can be manipulated. A virtual conference room 26 can comprise any setting, such as a presentation hall, a beach, a museum, a theatre, etc. A participant preference can be for the view to always feature the current speaker in frame. The conference room 26 view of one participant can include only other participants avatars involved in the conference, or, all other participants avatars along with the viewer's avatar. All parameters associated with the virtual environment can be created using a virtual environment markup language.

All participants having a local database and memory system 52 maintain a complete representation of the virtual conference room 26 including all objects disposed within. More than one conference room 26 may be created in each processor/server 28 in the network. Each virtual conference room 26 can be given unique identification information by which can be accessed by users of the conference room 26. The virtual conference room 26 may contain the identities of all processors/servers 28 connected to a conference. There may be one or more meetings held in a virtual conference room 26, each of which can also be given unique identification information. The virtual conference room 26 may also contain information about access rights of potential participants based upon conference privilege. Access rights may be stored in the memory system 52. It may also be advantageous to track the time of a conference including the start time and running time.

Conference room 26 can be rendered on a display 38 or can represent information or data held within the memory system 52. Each participant is represented by at least one live virtual image as if the participants were present in a real-life conference setting. Conference room 26 has within it a plurality of avatars 102, with each avatar representing a different conference participant, such as conference participants 20, 21, 22, and 23. Also, given that the participants are themselves virtually represented, a given avatar can be the representation of several cooperating participants. A single participant of sufficient skill can also manipulate several avatars. And finally, an avatar may have no human participant at all, such as a conference room administrative assistant 104, or virtual secretary. A combination of conference room assistants facilitates participants with limited input capabilities and provides them with a greater level of interaction. Assistants can include menu-driven computer programs such as search engines linked to other networks including global networks like the Internet.

Conference room 26 further contains several functional items that may be accessed or used by the conference participants. For example, a whiteboard 106 may be used for drawing, displaying, manipulating data, and making other entries into the virtual space. The whiteboard 106 thus simulates an actual whiteboard or similar writing space that might be used in an actual face-to-face conference. A closet 108 disposed within the virtual room 26 may contain a film or overhead projector 110 that may be removed from the closet 108 and used to display multimedia applications, such as a movie or slide presentation. A podium 112 may also be disposed within the room and may be used for drawing attention to a speaker. An avatar 102 may possess a pointer 114 which may be used to draw attention to an item of interest, such as something drawn on the whiteboard 106 by any one of the participants. Once a selection of a functional item has been made, the change in status information concerning the functional item is then updated on the other participant's processor/server 28 via the network. The functional item selection process may be analogous to the well known “point and click” graphical user interface method wherein a mouse-type input device is used for positioning a cursor element and selecting a functional item.

In one embodiment, a gesture markup language is used to direct the actions of an avatar once it has been described. A repeatable human action, such as pointing a finger or winking can be reduced from a significant amount of visual data to a simple markup such as <WINK EYE=“LEFT” LENGTH=“2 seconds”/>. Voice commands can also be used to move an avatar. For example, when a participant says a certain verb, such as stand up, the avatar may respond accordingly.

By using a markup language, a participant is able to replay parts of a presentation, mute, focus, ignore various people, and change vantage points both possible and physically impossible on the fly. All actions taking place within the virtual conference room can be recorded onto each participant's memory system 32.

In one embodiment, voice communication with other participants is handled via voice over IP (voice delivered using the Internet Protocol) technology. In an alternative embodiment, voice communication may be handled out of band through a separate circuit-switched conference bridge. Voice over IP is a term used in IP telephony for a set of facilities for managing the delivery of voice information using the Internet Protocol. In general, this involves sending voice information in digital form in discrete packets rather than in the traditional circuit-committed protocols of the Public Switched Telephone Network (PSTN). Voice over IP takes voice data and compresses it because of the limited bandwidth of the Internet. The compressed data is then sent across the network where the process is reversed.

A major advantage of voice over IP and Internet telephony is that it avoids the tolls charged by the ordinary telephone service. With voice over IP technology, a user can combine voice and data over an existing data circuit. Voice over IP derives from the VoIP Forum, an effort by major equipment providers, including Cisco, VocalTec, 3Com, and Netspeak to promote the use of ITU-T H.323, the standard for sending voice (audio) and video using IP on the Internet and within an intranet. The Forum also promotes the use of directory service standards so that users can locate other users. Voice over IP uses real-time protocol (RTP) to help ensure that packets get delivered in a timely way. Using public networks, it is currently difficult to guarantee Quality of Service (QOS). Better service is possible using private networks managed by an Internet Telephony Service Provider (ITSP).

While the true audio stream can be put into the virtual space and used as a controller to drive the avatar's facial expressions to “mouth” the words, more aptly, the speech can be converted to a phonetic language and sent to the space via a markup language. The scripting of avatar gestures and phonetics allow a participant to enter a command, such as “smile” or “laugh hard” or “sneeze”, and have a series of gestures and phonetics be sent in sequence. A voice characteristic markup language can also be used to describe the characteristics of a given speaker's voice and the repeatable idiosyncrasies of the voice (i.e. the standard phonetic mappings and any nonstandard noises the speaker makes regularly). A phonetic markup language can provide the continuous audio description of the participants.

An avatar's 102 behavior may be controlled by synchronizing it's facial expressions to the voice of the participant, a markup language expressing specific actions, or a combination of these technologies. An avatar's facial expressions may be synchronized to a participant's voice such that an emphasis in the participant's voice may lead an avatar to act in a certain way, for example, acting excited.

The human markup language describing the avatar, the phonetic markup language describing the audio, and the environment markup language describing the virtual environment can all be modified over time. New elements can be introduced, destroyed, modified, etc. in the environment. Hyperlinks can also be provided for access to out-of-conference items (e.g. a document having a link to it's web or local file equivalent).

To move an avatar 102 within the virtual environment 26, a participant can use a keyboard 30, joystick 36, mouse 32, or whatever else is available to make the avatar act in the way that a participant desires. When a participant immerses into the virtual environment 26, the participant first creates a virtual representation of him/herself using the markup language described above. The virtual representation is then sent and downloaded to all participants over the network so that all the other participants are able to see the immersing participant's avatar in the virtual conference environment 26. A participant's avatar moves in response to data detected by input devices. This occurs, for example, when a participant actuates directional keys on a keyboard 30 in order to move his/her avatar around the virtual conference room 26. When the avatar moves from one location to another within the room 26, the legs of the avatar move to simulate a walking motion. Data indicating the state, position, etc., of this action is sent to the processors/servers 28 of all the participants so that the positions and leg patterns of the avatar change in the same manner on the display 38 of each participant. An avatar may move freely within about the virtual conference room 26 and is constrained only by the limits of the input devices and obstacles within the conference room 26.

Based on the rules of space, avatars can directly interact with other avatars and objects which affect the logical location of the avatars. For example, one avatar may push another out of the way, this may in turn generate additional gestures not initiated by the participant being moved.

The present invention has been described by way of example, and modifications and variations of the exemplary embodiments will suggest themselves to skilled artisans in this field without departing from the spirit of the invention. The preferred embodiments are merely illustrative and should not be considered restrictive in any way. The scope of the invention is to be measured by the appended claims, rather than by the preceding description, and all variations and equivalents which fall within the range of the claims are intended to be embraced therein.

What is claimed is:

1. A virtual conferencing system, comprising:
at least one local client processor/server operatively connected to a communications network operable for virtual environment and avatar rendering using a descriptive computer markup language;
a central server acting as a broker between the at least one local client processor/server and operable for coordinating virtual environment and avatar state changes;
at least one input device operable for performing the virtual environment and avatar state changes; and
an output device operable for displaying the virtual conference environment.

2. The virtual conferencing system of claim 1, wherein the descriptive computer markup language comprises an extensible markup language (XML).

3. The virtual conferencing system of claim 2, wherein the markup language comprises at least one of the following: a human markup language used to describe the avatar, a virtual conference environment language, an environment modification language, a gesture markup language, a voice characteristic markup language, and a phonetic markup language.

4. The virtual conferencing system of claim 1, wherein the communications network is accessed via a low speed analog dial-up connection.

5. The virtual conferencing system of claim 1, further comprising:
an audio input device operable for inputting conference participants voice communications; and
an audio output device operable for outputting the conference participants voice communications.

6. The virtual conferencing system of claim 5, wherein the voice communications are handled via voice over Internet Protocol technology.

7. The virtual conferencing system of claim 5, wherein the voice communication is handled out of band via a separate circuit-switched conference bridge.

8. The virtual conferencing system of claim 1, wherein the avatar comprises at least one of: a conference participant and a virtual conference assistant.

9. The virtual conferencing system of claim 1, wherein the central server is further operable for sending full state information at regular intervals for the purpose of correcting discrepancies between the conference participant and their avatars caused by lost or damaged data.

10. The virtual conferencing system of claim 1, wherein the avatar's behavior is controlled by synchronizing the avatar's facial expressions with the voice of the conference participant.

11. A method of conferencing a plurality of clients that are connected via a global communication network, comprising the steps of:
establishing at a first local client processor/server a virtual conference environment using a descriptive environment markup language;
establishing a first personal avatar of the first local client processor/server using a descriptive human markup language;
establishing a communication between the first local client processor/server and a second local client processor server utilizing an Internet Protocol address, wherein the conference communication comprises data and audio information;
transmitting virtual conference environment data and avatar data from the first local client processor/server to the second local client processor/server via the global communication network;
establishing a second personal avatar of the second local client processor/server using the descriptive human markup language;
enabling the first and second local clients to interactively participate in a virtual conference, via the communication network, by performing avatar actions within the virtual conference environment;
enabling the first and second local clients to change the virtual conference environment using the descriptive environment markup language; and
detecting the actions of the first and second personal avatars.

12. The method of claim 11, wherein the step of changing the virtual conference environment comprises introducing, destroying, and modifying elements over time.

13. The method of claim 11, wherein the step of performing avatar actions within the virtual conference environment comprises creating avatar state changes using an input device.

14. The method of claim 11, wherein the audio information is transmitted via voice over Internet Protocol technology.

15. The method of claim 11, wherein the audio information comprises local client voice communication that is synchronized with the avatar's facial expressions using a voice characteristic and a phonetic markup language.

16. The method of claim 11, further comprising:
transmitting the virtual conference environment data and avatar data from the first local client processor/server to any number of local client processors/servers connected to the communication network.

17. The method of claim 11, wherein the communications network is accessed via a low speed analog dial-up connection.

18. A communication network capable of establishing a connection between a plurality of conference participants for the purpose of performing a virtual conference, comprising:
at least one processor/server in the communication network comprising a virtual conferencing software module disposed within a memory system, wherein the virtual conferencing software module supports a structure and layout of a virtual conference room, animated avatars, tools, and interactions of the animated avatars within the virtual conference environment, wherein the memory system includes information for the appearance of the avatars that populate the virtual environment, conference facilities, documents, and multimedia presentation materials, and wherein the virtual conference processor/server acts as a broker between a plurality of local client processors/servers and is operable for coordinating virtual environment and avatar state changes;
at least one input device operatively connected to the at least one processor/server and operable for performing virtual environment and avatar state changes; and
at least one output device operatively connected to the at least one processor/server and operable for outputting audio data, displaying a virtual conference environment, displaying a plurality of avatars, and displaying the virtual environment and avatar state changes.

19. The communication network of claim 18, wherein the virtual conference room, animated avatars, and tools are created using a descriptive computer markup languages comprising an extensible markup language (XML).

20. The communication network of claim 18, wherein the communication network is accessed via a low speed analog dial-up connection.

21. The communication network of claim 18, wherein the audio data is handled via voice over Internet Protocol technology.

22. The communication network of claim 18, wherein the audio data is handled out of band via a separate circuit-switched conference bridge.

23. The communication network of claim 18, wherein the at least one processor/server is further operable for sending full state information at regular intervals for the purpose of correcting discrepancies between the conference participants and their avatars caused by lost or damaged data.

24. The communication network of claim 18, wherein the avatar's behavior is controlled by synchronizing the avatar's facial expressions with the voice of the conference participants.
